(19) United States
(12) Patent Application Publication
(10) Pub. No.: US 2026/0287743 A1
(43) Pub. Date: Sep. 24, 2026

(54) INTELLIGENT UNDERWATER ACOUSTIC IMAGING SYSTEM AND CORRESPONDING METHOD

(71) Applicant: Wass Submarine Systems S.r.l., Livorno (IT)

(72) Inventors: Fabrizio FERRAIOLI, Livorno (IT); Antonio LAGUDI, Livorno (IT); Fabio BRUNO, Livorno (IT); Marino MANGERUGA, Livorno (IT); Umberto SEVERINO, Livorno (IT)

(73) Assignee: Wass Submarine Systems S.r.l., Livorno (IT)

(21) Appl. No.: 19/476,732

(22) PCT Filed: Apr. 17, 2024
(86) PCT No.: PCT/IB2024/053745

§ 371 Date: Oct. 20, 2025

(30) Foreign Application Priority Data
Apr. 21, 2023 (IT) 102023000007836

(51) Int. Cl. G01S 15/89; B06B 1/06

(52) U.S. Cl. CPC G01S 15/89; B06B 1/0622; B06B 2201/74

(57) ABSTRACT

An underwater acoustic imaging system, designed to be coupled to a water vehicle, is provided with: an acoustic imaging device, to acquire three-dimensional acoustic images of a water volume; a mechanical movement module, coupled to the acoustic imaging device to cause underwater movement thereof; and an electronic unit coupled to the acoustic imaging device and to the mechanical movement module. The electronic unit controls the mechanical movement module to implement two distinct operating phases of the acoustic imaging device, cooperating to generate a continuous stream of said three-dimensional acoustic images: a searching phase, in which the acoustic imaging device is designed to be held substantially still and is configured to perform a scan as a result of a movement of the water vehicle; and an in-depth analysis phase, in which the acoustic imaging device is designed to be driven in a scanning movement by the mechanical movement module for an in-depth analysis of an element of interest identified in the water volume.

### CROSS-REFERENCE TO RELATED APPLICATIONS

This Patent Application claims priority from Italian Patent Application No. 102023000007836 filed on Apr. 21, 2023, the entire disclosure of which is incorporated herein by reference.

### TECHNICAL FIELD

The present solution relates to an intelligent underwater acoustic imaging system and to a corresponding method.

### BACKGROUND

Underwater imaging systems are used in a variety of fields, e.g., for displaying items which intentionally, e.g., pipes or other structures, or unintentionally, e.g., wrecks, archaeological finds or the like, are found on sea, river or lake bottoms.

Underwater imaging systems are also used for exploration and research purposes in the biological or geophysical field, e.g., for displaying and investigating geothermal phenomena (such as underwater hydrothermal emissions, known as fumaroles).

The expected output from an underwater imaging system is generally a three-dimensional representation obtained by means of appropriate visualization software of a given scene potentially containing elements of interest.

Known imaging system solutions may not be entirely satisfactory, at least in certain applications.

In particular, optical imaging systems are effective over short distances, but only if there is sufficient light and clarity.

In those situations in which optical systems are not applicable due to the limited range of electromagnetic signals and/or the water is murky or otherwise does not have sufficient visibility, acoustic, ultrasound technologies are used to display objects in digital form.

Such an acoustic imaging system is necessarily of an active type, having to include a section dedicated to the transmission of coded acoustic signals having certain features and a group or array of sensors designed to receive the echo reflected by the scene.

Traditional sonar-based acoustic systems operate at long distances and great depths, but generally do not have a sufficient resolution to provide the details required for some applications.

Acoustic cameras use an array of high-frequency transducers to focus the acoustic energy and produce video images similar to fast frames. Such acoustic cameras operate at higher frequencies and shorter distances with respect to conventional sonar systems. The acoustic cameras transmit multiple, parallel, narrow beams and receive the return signals. These systems generate sharper images with respect to conventional sonar, but the higher frequencies required limit the corresponding range of application.

### SUMMARY OF THE INVENTION

The aim of the present solution is generally to provide an underwater acoustic imaging system, in particular of a three-dimensional type and operating in real time, which represents, at least in some respects, an improvement of known systems.

According to the present solution, therefore, an underwater acoustic imaging system and a corresponding method are provided, as described in the appended claims.

### BRIEF DESCRIPTION OF THE DRAWINGS

To better understand the present solution, preferred embodiments thereof will be now described, for exemplary and non-limiting purposes, and with reference to the appended claims, in which:

FIG. 1 is a general block diagram of an acoustic imaging system according to the present solution;

FIGS. 2A and 2B are schematic depictions of a searching phase and, respectively, an in-depth analysis phase in the system of FIG. 1;

FIGS. 3 and 4A are schematic depictions relating to acoustic imaging data generation operations performed by a scanning device in the system of FIG. 1;

FIG. 4B schematically shows a rotational movement of a scanning device in the system of FIG. 1;

FIG. 5 is an exemplary visualization of an acoustic image by a displaying unit in the system of FIG. 1;

FIG. 6 is a general block diagram of an analysis module in the system of FIG. 1;

FIG. 7 is an exemplary visualization of analysis results by the analysis module of FIG. 6; and

FIG. 8 is a flow chart of operations associated with an intelligent acoustic imaging method implemented by the system of FIG. 1.

### DESCRIPTION OF EMBODIMENTS

As will be described in detail below, an aspect of the present solution involves implementing an intelligent underwater acoustic imaging system, provided with autonomous intelligence, which allows the three-dimensional display, also in real time, of a water volume potentially containing elements of interest, such as submerged objects, for example lying on the seabed, such as inhomogeneities or gaseous emissions (fumaroles). Advantageously, the system is provided with artificial intelligence in order to identify and possibly recognise the aforesaid elements of interest in an at least partly automated manner by means of appropriate algorithms, and thus enable an in-depth or detailed analysis.

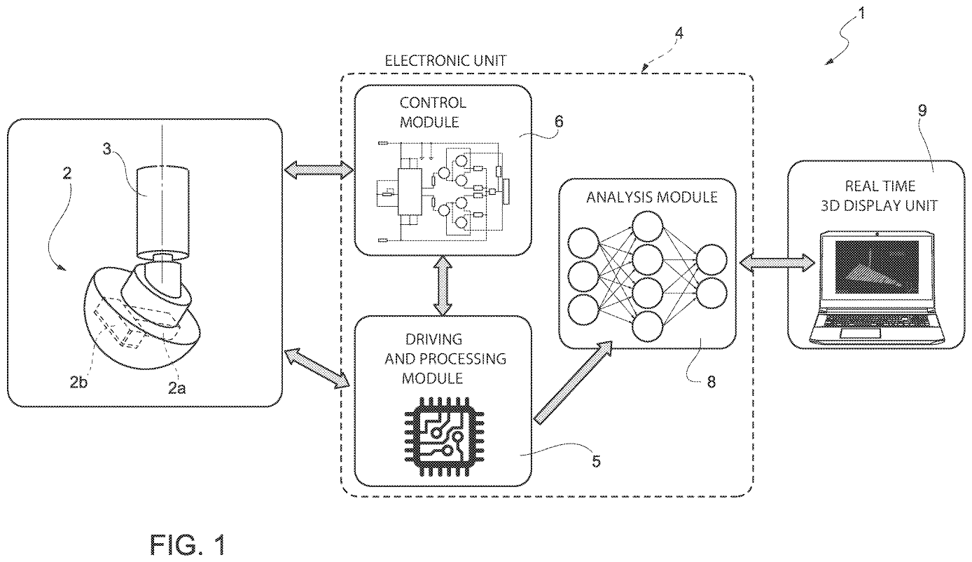

As shown schematically (and merely by way of example) in FIG. 1, an underwater acoustic imaging system 1 comprises:
a scanning device 2, provided with an array of transmitting acoustic elements or transducers (hereinafter referred to as transmitting array 2a) and an array of receiving acoustic elements or transducers (hereinafter referred to as receiving array 2b), oriented crosswise, in particular orthogonally, to one another, e.g., in what is called a “T-shaped” configuration; and
a mechanical movement module 3, integrally coupled to the scanning device 2 to cause underwater movement thereof, under certain operating conditions, so that the aforesaid scanning device works in a hybrid scanning, mechanical for transmitting and electronic for receiving (as will be discussed in detail below).

The aforesaid acoustic transmitting and receiving elements are, for example, piezoelectric transducers formed for example by piezoceramic blocks.

In an embodiment, the transmitting and receiving arrays 2a, 2b consist of equal and equally spaced acoustic elements (being of the ULA—Uniform Linear Array—type) and have a fan-shaped directivity pattern (fan beam), with the width of the main lobe being conditioned by the length of the array (resulting in a composite beam known as a pencil beam).

The aforesaid mechanical movement module 3 is configured to cause a movement even of a single degree of freedom, controlling the positioning of the acoustic arrays according to an azimuth angle (e.g., in an angular range comprised between 0 and 350°); it is also possible to add an elevation orientation (e.g., in an angular range comprised between 0 and 90°) to such a scanning movement, extending the acoustic angular coverage capabilities of the arrays.

The mechanical movement module 3 may comprise an electric drive with speed and position control, e.g., with a synchronous electric motor with permanent magnets and a position transducer (e.g., a resolver or an encoder). The electric motor and the power and signal cables are advantageously sealed so that they can operate in water up to an assigned depth.

The acoustic arrays can be connected directly, e.g., by means of a flange (suitably shaped and inclined), to the motor axis without motion transmission systems.

A further electric motor with relating position transducer can be present, thus obtaining a pan&tilt system, in which the control of a further angular degree of freedom allows to vary the framing of the scene in a desired manner.

The scanning device 2 and the mechanical movement module 3 may, for example, be carried by a surface or deepwater platform or vehicle (not illustrated herein), e.g., being mounted on a simple pole connected to the same platform or coupled by means of an appropriate deployment system (not described herein).

Alternatively, the platform to which the scanning device 2 and the movement module 3 are coupled can advantageously be a remotely guided underwater vehicle, ROV, or autonomous underwater vehicle, AUV.

The underwater acoustic imaging system 1 further comprises an electronic unit 4 coupled to the aforesaid scanning device 2 and mechanical movement module 3.

Such an electronic unit 4 comprises:
a driving and processing module 5, coupled to the scanning device 2 to provide appropriate driving signals and to process received signals (like raw data) and output acoustic imaging data, representative of the scene being acoustically scanned, potentially containing elements of interest;
a control module 6, coupled to the mechanical movement module 3 to drive and control movement of the scanning device 2; and
an analysis module 8, coupled to the driving and processing module 5 and configured to receive the acoustic imaging data and perform appropriate processing and analysis of the same data, advantageously in an automated or partially automated manner, for processing the scene and identifying and analysing the aforesaid elements of interest.

As will be discussed below, according to an aspect of the present solution, the analysis module 8 may provide an analysis of the aforesaid elements of interest using artificial intelligence, e.g., with machine learning, deep learning algorithms, artificial neural networks, etc.

In more detail, the driving and processing module 5 of the electronic unit 4 comprises a transmitting section and a receiving section, as well as a power section which allows electrical power to be converted from an electrical power source into acoustic power to be transmitted underwater.

As far as the transmitting section is concerned, the signal to be transmitted (digital code) is stored and cyclically converted into an analogue signal, amplified and sent to the transmitting array 2a. The cyclic nature with which it is transmitted (ping frequency) depends on the distance from the scene. The transmitting section may further comprise a tuning circuit for minimising reactive power absorption.

The receiving section consists of an analogue pre-amplification section, an analogue-digital conversion section and a subsequent digital section, in which the receiving signals are frequency re-phased to obtain the acoustic imaging data for subsequent processing (prior to beamforming, the acoustic signals on the various channels may also be subjected to further processing, which can also be of an analogue nature and which may include demodulation, low-pass filtering and decimation).

The functions described above can be allocated to one or more electronic boards.

The control module 6 is also operatively coupled to the driving and processing module 5, so as to “synchronise” the generation of the acoustic imaging data to the movement imparted by the mechanical movement module 3 to the scanning device 2 (in particular, so that the cyclic transmission of acoustic signals is synchronised with the motion imposed by the drive).

The communication between the aforesaid control module 6 and driving and processing module 5 may be implemented by means of a Ethernet communication, for example.

In particular, given the relative displacement between the transducer arrays and the scene, the closed-chain controlled drive by the control module 6 communicates its position to the driving and processing module 5 for the correct positioning of the acquired image points in an appropriate global reference system.

The electronic unit 4 can be carried by the aforesaid platform, be it a surface vehicle or an underwater vehicle, e.g., ROV or AUV, and can also be provided with remote data communication capabilities (preferably of a wireless type).

The underwater acoustic imaging system 1 further comprises a displaying unit 9, coupled to the electronic unit 4 and configured to provide on-screen representations of the acoustic imaging data and analysis results, and also to offer a user interface for an operator for interaction with the underwater acoustic imaging system 1.

The displaying unit 9 may, for example, be implemented by a processor, such as a personal computer, desktop, laptop, or tablet, and be positioned at the aforesaid platform, or remotely.

According to a particular aspect of the present solution, the underwater acoustic imaging system 1 is configured to operate in two distinct, complementary and cooperating phases for the generation of a continuous stream of images, in particular of a three-dimensional type: a first “discovery” phase, or long-distance searching phase, in which processing of the acoustic signals is aimed at detecting the presence of certain elements of interest in the scene; and a second “classification” (or pattern recognition) or in-depth analysis phase, which envisages an approach of the platform to a region of interest and the generation and analysis of detailed images, with the same platform held substantially still or hovering.

The aim of this second phase can be manifold and can include the detection and/or recognition of details, e.g., geometrical, of a given element of interest as well as, in principle, also the type of material producing the backscattered signal based on appropriate analyses of the received echo, or even the estimation of the speed of a given moving element by means of Doppler effect analysis.

As will be discussed in detail, in the first phase, the scanning device 2 is held substantially still and the scene is scanned due to the effect of the platform movement.

Conversely, in the second phase, the scanning device 2 is driven by the mechanical movement module 3 so that it operates in hybrid scanning, mechanical for transmission and electronic for reception. In particular, the mechanical scanning allows generation of three-dimensional images in real time and complements the scanning mode based on the platform motion, so as to generate a continuous stream or flow of images.

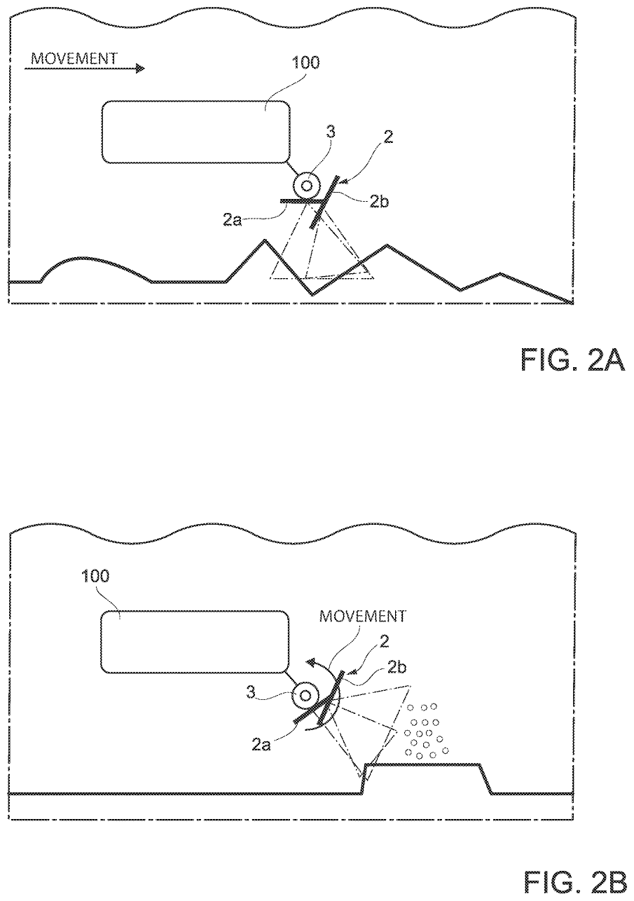

In detail, during the searching phase (illustrated schematically in FIG. 2A), the scanning device 2 of the underwater acoustic imaging system 1 operates at a reduced operating frequency, which is for example comprised between 100 kHz and 200 kHz in order to be able to operate at great distances, e.g., a few hundred metres.

The choice of the operating frequency is a compromise between the compensation of transmission losses and the strength of the echo signal (frequency also conditioning the spatial resolution as well as the duration of the transmitted pulse).

In the searching phase, the transmitting array 2a of the scanning device 2 is maintained in a substantially horizontal position with respect to the seabed, with a main axis which may coincide with a bow-stern axis of the platform or water vehicle (herein indicated with 100), and produces a fan beam which traverses a section of water transverse to the motion of the platform and “illuminates” a strip of the same seabed (the transmitting array 2a does not perform beamforming operation). The receiving array 2b, which instead performs the beamforming, is orthogonal to the transmitting array 2a.

In reception, the electronics coupled to the scanning device 2 form a large number of beams orthogonal to the transmitted beam, obtaining a strip of pixels of the seabed for each transmitted beam.

This concept is schematically illustrated in FIG. 3, where it is highlighted how the antenna system acoustically generates the individual pixels of the scene. Basically, the imprint of the fan beam transmitted on the scene is a strip of varying thickness in relation to the aperture of the beam and the distance of the transmitting array 2a from the scene. The receiving array 2b, arranged orthogonally, explores the same scene and from the intersection of the two beams, the areola of the selected area is obtained (the transmitter and receiver both being of the ULA type and orthogonal to each other, a resultant or composite beam pattern is obtained which originates from two fan beams to produce a pencil beam).

In particular, the different points of the illuminated strip are analysed through a beam forming process in reception (operation known as electronic beam steering), which allows the main receiving lobe to be oriented in an assigned direction by appropriately re-phasing the received signals in the time domain or frequency domain.

By exploiting the forward motion of the platform (schematically shown by the arrow in FIG. 2A), a certain number of vertical sections (seabed strips) in the unit of time are thereby obtained, which together compose a three-dimensional image of the seabed.

In particular, in this searching phase, the possibility of also providing the image in a plane of the entire water column (i.e., of a portion of the water mass directly below the scanning device 2, arranged transversally to the seabed) together with the three-dimensional image of the seabed is particularly useful for searching for particular elements of interest, for example associated with hydrothermal phenomena (such as gaseous inhomogeneities).

Once an element interest, or target, has been identified in a given position (advantageously, as will be discussed below, automatically by means of artificial intelligence techniques), the platform may then approach and stop in such a position (in the case of an ROV or AUV, the platform would remain still, hovering).

The acquisition of the three-dimensional images occurs in this phase by mechanical scanning (not by exploiting the movement of the platform), whereby the movement module 3 is activated, which determines appropriate driving of the scanning device 2.

The classification phase thus begins (as schematically illustrated in FIG. 2B, where again the platform, in this case still, is indicated with 100), which occurs by moving according to at least one degree of freedom, e.g., with a rotation in a horizontal plane, parallel to the seabed or inclined with respect to the same seabed, the acoustic arrays with an appropriate angular pitch and composing a three-dimensional image of the target by assembling a series of horizontal sections and corresponding distance profiles.

As indicated above, the electric drive can also envisage two degrees of freedom, according to a panstilt type of movement, allowing a greater operating flexibility. In particular, it is thereby possible to always frame the scene in optimal angular resolution conditions while exploiting, on average, maximum angular resolution conditions.

In this classification phase, the underwater acoustic imaging system 1 substantially behaves like an intelligent three-dimensional acoustic imaging system with real-time acquisition capabilities.

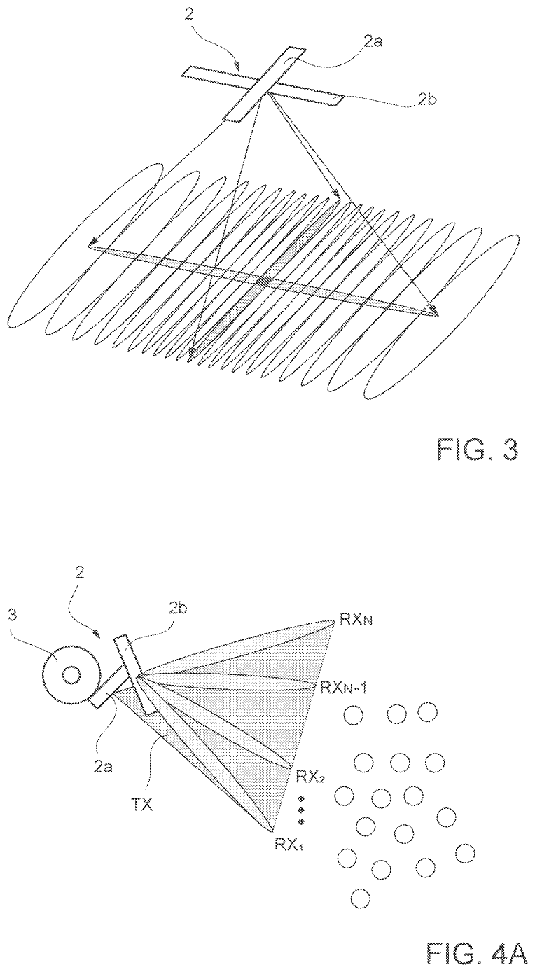

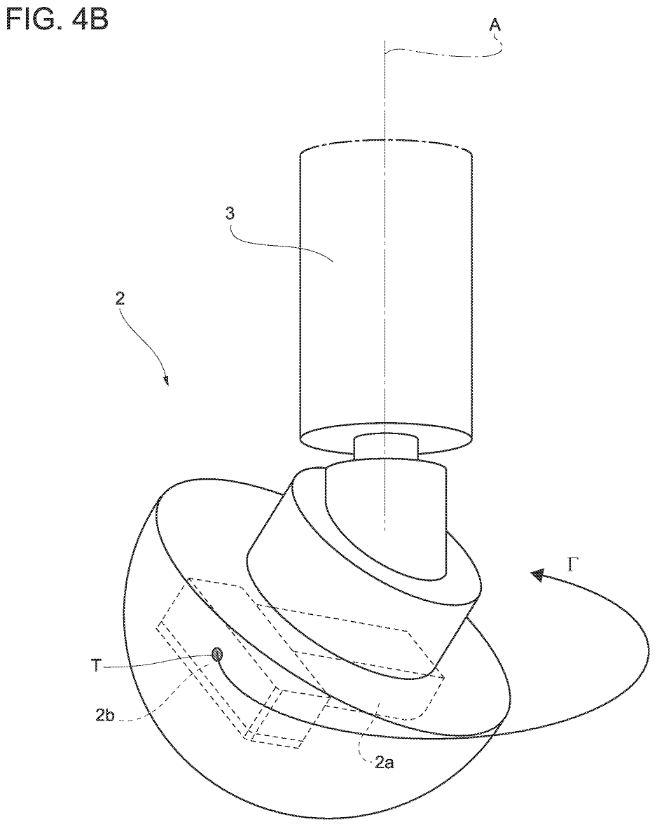

FIG. 4A schematically shows the beam transmitted by the transmitting array 2a and a number N of receiving beams obtained by electronically steering the receiving array 2b, which allow creating the pixels of the image representative of the scene (in this case containing, as an element of interest, a gaseous emission).

In more detail, the mechanical scanning involves the phase centre of the transmitting and receiving arrays 2a, 2b to undergo a shift during acquisition.

In this regard, reference can be made to FIG. 4B in which a model is shown of the arrays moved by the underwater electric drive (the aforesaid mechanical movement module 3, having vertical axis A in the example) and connected to the same electric drive by means of a coupling element at a certain angle of inclination with respect to the seabed.

The rotation occurs around the vertical axis A and scanning occurs with an oblique transmitting fan beam (e.g. with 150° angular aperture), which moves over a conical surface. For each position of the transmitting beam, the receiving array generates up to a thousand beams orthogonal to the transmitting beam, generating the image pixels. The mechanical scanning effect is to make each acoustic transducer, indicated with T in the aforesaid FIG. 4B, draw an arc of circumference Γ lying on a plane which is inclined with respect to the seabed.

According to an aspect of the present solution, a different operating frequency is used in this classification phase with respect to that used in the searching phase; in particular, the operating frequency used in this phase is higher, e.g., with a value in the order of 0.5 MHz, to be able to operate at distances ranging from a few metres to a few tens of metres. In this phase, being able to operate in VHF, the acoustic imaging system 1 is capable of producing very high-resolution images of details at even very short distances from the scene of interest.

The refresh (practically in real time) of the image in the classification phase is achieved by cyclically moving the arrays clockwise and counter-clockwise, in particular carrying out the mechanical scanning with a cyclically clockwise and counter-clockwise rotation. The set rotation speed and the frequency with which the packets are transmitted conditions the resolution of the image according to the angle controlled by the drive (the resolution also being conditioned by the distance between the system and the scene).

In particular, the angle set for the mechanical scanning identifies one of the angular amplitudes through which the scene is framed; advantageously, such an angle can be set virtually to 360°, thus obtaining panoramic images.

It is underlined that the shift between the aforesaid searching and classification phases may be implemented by controlling the aforesaid movement module 3; such a shift may also be implemented in a fully automated manner, as a function of the analysis of the acoustic imaging data by the analysis module 8 (for example, as a function of the identification and localisation of an element of interest in the scene).

The analysis module 8 of the electronic unit 4 of the underwater acoustic imaging system 1 and the corresponding operation, for detection and displaying of elements of interest (e.g., gaseous emissions on the seabed), starting from the acquired acoustic imaging data, and for their analysis and representation in a three-dimensional environment, is now described in greater detail.

Data are processed by means of suitable algorithms which determine, for each direction of space explored, whether there is an element of interest (target) and at what distance. This can occur by means of processing the peaks of the signals in time obtained downstream of the beam forming in reception. The final result of such processing is a point cloud in space, which can be displayed in a three-dimensional environment.

In particular, such visualization may be customised and oriented to the analysis of particular targets. The customisation may concern, for example, the spatial filtering techniques adopted and the possibility of “colouring” the displayed point cloud by means of scalar fields of interest, such as backscattering intensity.

Using a false-colour system, it is possible to identify, for example, regions of the scene with higher or lower acoustic backscattering. Such additional information can contribute to identifying elements of interest in an acoustic scene.

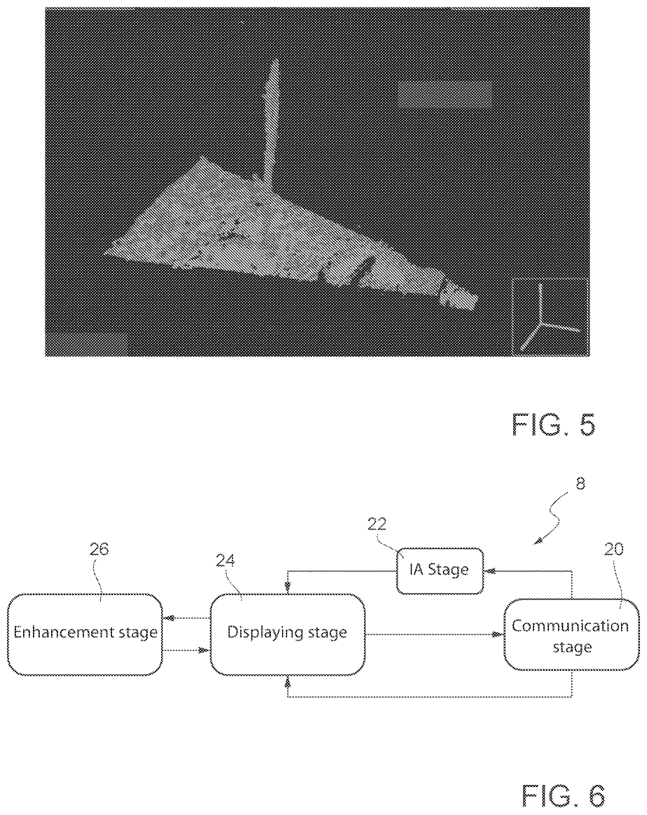

By way of example, a possible three-dimensional visualization of a target (a cloud of air bubbles) with a customised display for such a target is shown in FIG. 5.

Furthermore, the analysis module 8 implements automatic detection functions by means of artificial intelligence techniques, e.g., by using convolutional neural networks.

Such detection functions can be used in particular in relation to the aforesaid searching phase, in which the generation of images exploits the motion of the platform, considering the entire three-dimensionality of the scene or certain two-dimensional sections of the same scene (possibly, the aforesaid functions may also be used in the aforesaid classification phase, during which the mechanical movement system is used for the real-time generation of three-dimensional images).

For example, an automatic detection algorithm of an element of interest (such as a gaseous emission or fumarole) receives as an input two-dimensional representations (images) of the water column and, after applying artifact reduction filters and emphasising features related to the element of interest, may send the images to a Convolutional Neural Network (CNN), which performs a binary classification to discriminate whether or not typical features of the same element of interest are present in the image.

During the classification phase, the analysis module 8 is capable of producing detailed three-dimensional representation of the element of interest (e.g., the fumarole) and its evolution over time. In particular, such an analysis module 8 is configured to:
receive individual scans of the scene (and element of interest) and store them if required;
apply improvement algorithms to the acquired point cloud (including smoothing, outlier detection, denoising, or similar algorithms);
select only the part of the graph which represents the element of interest, filtering out the rest (seabed or other); and
depict the evolution of the element of interest over time.

In more detail, and referring to FIG. 6, the analysis module 8 comprises:
a communication stage 20, operatively coupled to the scanning device 2 (not illustrated herein) for receiving in real-time the acoustic imaging data (data to be processed) and also to the mechanical movement module 3 (also not illustrated), for the synchronisation of the acoustic imaging data with the drive imparted to the same scanning device 2 (during the aforesaid classification phase);
an artificial intelligence stage 22, which receives from the communication stage 20 data required to perform the detection and/or recognition of the possible presence of an element of interest (e.g., a fumarole) in the water volume (e.g., on the seabed) and outputs information related to the detection of the same element of interest;
a displaying management stage 24, which receives a data stream from the communication stage 20 related to a point cloud reconstructed starting from the acoustic imaging data and also detection information of the possible presence of elements of interest on the seabed from the artificial intelligence stage 22, and is configured to manage the visualization of said point cloud and additional information related to the aforesaid elements of interest by means of the displaying unit 9 (not illustrated herein), to which said displaying management stage 24 is communicatively coupled; and
an improvement stage 26, coupled with the displaying management stage 24 and configured to perform appropriate processing of the acquired point clouds by means of algorithms for improving the features of the same point clouds.

By way of example, the displaying management stage 24 may apply appropriate contrast and/or colouring algorithms to highlight the details of interest within the point cloud and in particular to highlight the evolution thereof over time, for example by highlighting successive scans carried out on the same element of interest with different colours. In a possible implementation, such a colouring can be based on a colour scale with greater contrast which is applied unevenly over the point cloud, using more colours in areas with a greater number of points.

The improvement stage 26 can process the point clouds through a series of noise and outlier removal algorithms. Some of the outliers in the acquisitions can be removed through a statistical analysis of the “neighbourhood” of each point in the cloud and eliminating the points which do not meet certain criteria. One of these algorithms can be the Sparse Outlier Removal (SOR) algorithm, based on the calculation of the distribution of points taking into account the distance to neighbouring points. For each point, the average distance from its neighbours is calculated. Assuming that the resulting distribution is Gaussian with its own mean and standard deviation, all the points for which the average distance is outside a range defined on the basis of this distribution, are considered outliers and are thus eliminated from the point cloud.

The artificial intelligence stage 22 has, as indicated above, the function of detecting an element of interest from the analysis of the acoustic images and also of its georeferencing, e.g., coupling the image to which an epoch (i.e., an acquisition time period) is associated with the global coordinates of the acoustic system (provided, for example, by a GPS tracking system) in the same acquisition time period.

In particular, the artificial intelligence is appropriately trained to recognise the presence of elements of interest (discriminating them from phenomena which produce a similar acoustic response but with different morphological features), automatically detecting such elements. Subsequently, by means of the synchronisation with GPS navigation data (provided, for example, by the platform to which the underwater acoustic imaging system 1 is coupled), a congruently sized region, in which the element of interest has been identified, is detected with a certain probability.

Operation of the artificial intelligence stage 22 therefore consists of two phases, a detection phase and a georeferencing phase.

Within the detection phase, the images of the water volume (e.g., water column) are pre-processed to highlight the information content present therein. The images produced, when obtained from raw data, cam be affected by artefacts which have no physical correspondence in reality. The filtering process compensates for the artefacts by considering, for example, the average intensity level of the acoustic image, averaging over this value and eliminating the threshold values. Having a homogeneous image in terms of intensity, and thus in terms of colouring, a threshold filter can then be applied to bring out the features of the image. This thereby highlights the high-intensity components such as the seabed and any objects or phenomena (e.g., gaseous emissions) present in the water volume.

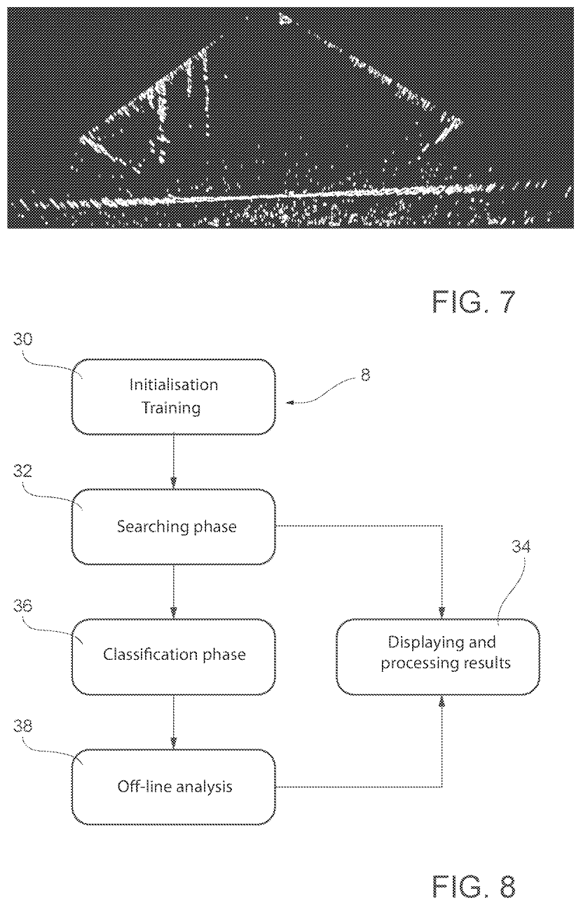

At this point, the image may assume a binary colouring as a function of the intensity threshold value, as shown for example in FIG. 7 (showing an example of a “wedge” image referring to a water column).

Afterwards, the image can be resized and provided as an input to an artificial intelligence algorithm, e.g., a convolutional neural network.

The convolutional neural network allows to match elements in the image also as a function of their spatial correspondence.

In an embodiment, the network used as a starting point for the detection of elements of interest from the acoustic images is the VGG-16 network, customised for the specific application, in particular with the addition of specific layers to prevent the training dataset from biasing the network's capacity.

The network training can be performed by assigning weights obtained using a reference dataset to each level of the network, and then performing a precise calibration on a dataset acquired during an experimental phase. In order to generalise the dataset as much as possible, distortions can be applied, scaling and mirroring, so as to increase the diversity between data (avoiding deviating too much from the real shape of the physical phenomenon, producing something implausible, thus applying slight alterations to the basic images). The experimental dataset can be divided into two groups, a training group and a validation group, e.g., according to 70/30 percentages.

The final output of the network can be a binary result: “1”, i.e., element detected; “0”, i.e., element not detected. Intermediate values therebetween may express the probability of the element being present.

The synchronisation between the artificial intelligence stage 22 and the navigation data is used to georeference the result of the neural network. The georeferencing phase synchronises the time information, the probability with which the element of interest was detected and the navigation data to define the area of interest where the element of interest was detected. Several elements detected in succession can result in a larger area and a different detection probability.

With reference to FIG. 8, a summary diagram of the operations performed by the underwater acoustic imaging system 1 is now described, also referring to what was discussed above.

In an initial phase, denoted with 30, prior to the real-time operation of the aforesaid system, initialisation and configuration operations are performed; furthermore, in such a phase 30, the training of the neural network which will be implemented by the artificial intelligence stage 22 of the analysis module 8 can be performed.

The actual operation envisages, in a phase 32, the execution of the aforesaid searching phase, with the platform moving and the scanning device 2 being maintained in a substantially horizontal position and operating at a first operating frequency, e.g., comprised between 100 kHz and 200 kHz, to provide acoustic images, including three-dimensional images of the water volume of interest (e.g., of the seabed), which are updated as a function of the movement of the same platform.

As denoted in phase 34, such acoustic images can be displayed in real (or near-real) time, e.g., by means of the displaying unit 9; furthermore, the acoustic images can be processed, e.g., by the aforesaid analysis module 8, for the automatic (or partially automatic) detection of certain elements of interest in the scene (e.g., inhomogeneities or gaseous emissions).

The searching phase is followed by the classification phase, denoted as phase 36 in the aforesaid FIG. 8, with the approach of the platform to a region of interest and the generation of detailed acoustic images.

The passage from the searching phase to the classification phase can be caused by the identification of elements of interest in the images acquired by means of the scanning device 2; in particular, such an identification may occur in an automated manner, by the aforesaid analysis module 8, which may implement the aforesaid artificial intelligence algorithms.

The shift to the classification phase then involves the substantial stopping or stationing of the platform and the start of the underwater movement of the scanning device 2 due to the mechanical scanning implemented by the mechanical movement module 3.

The scanning device 2 thus operates as a three-dimensional acoustic imaging system with real-time acquisition capability, with the image refresh obtained by cyclically moving the arrays, e.g., with clockwise and/or counter-clockwise rotation.

Thanks to the transition (in particular of an automated type, determined by means of artificial intelligence) between the two operating phases, it is possible to generate an essentially continuous stream of 3D images. The in-depth analysis phase occurs over short distances, at high resolution and in real time thanks to the high performance of the acoustic arrays.

The operating frequency of the scanning device 2 is also changed, passing to a second operating frequency, which is higher than the aforesaid first operating frequency, e.g., around 400 kHz (e.g., comprised between 400 and 500 kHz).

Even during the classification phase, as indicated in the aforesaid phase 34, the acoustic images can be displayed in real (or near-real) time and also processed, e.g., by the aforesaid analysis module 8, for the analysis of features of the elements interest identified in the scene (and possibly for the automatic recognition of such features by means of artificial intelligence) and also to follow the evolution of the analysed phenomenon over time (e.g., of a gaseous inhomogeneity).

As indicated in phase 38, a further processing phase, performed off-line, may be envisaged at the end of the classification phase, starting from data stored during the aforesaid search and/or classification phase, e.g., in order to perform further evaluations or more in-depth analysis of the elements of interest.

From what has been discussed, the advantages which the present solution allows to obtain are evident.

In particular, the aforesaid underwater acoustic imaging system 1 allows to generate three-dimensional or even two-dimensional (sectional) images in real or near-real time, with an operating mode which advantageously combines operation in searching or “discovery” mode with that in “classification” mode, while also providing automatic detection capabilities of elements of interest in a scene, with a wide viewing angle (even up to 360°).

The operation of the underwater acoustic imaging system 1 may therefore be an integral part of an underwater search and exploration mission and is closely coordinated with the kinematics of the platform, which is subservient to that of the underwater acoustic imaging system 1. In particular, off-line or on-line planning of the mission is aimed at an acoustic scan performed by means of an appropriate sequence of the two phases, depending on the operating context.

In particular, the discussed mechanical scanning mode in transmission combined with electronic scanning in reception is advantageous.

In a single device, both the sonar and acoustic camera functions are thus concentrated, with considerable savings in terms of size and weight coupled to the platform (with respect, for example, to the case in which two separate acoustic imaging devices are envisaged, e.g., a sonar and an acoustic camera). The proposed solution thus generalises the sonar concept, exhibiting the functionality thereof as a particular case of a more general and flexible scanning concept which also envisages the possibility of stationary or hovering platform operation.

The combined use of an underwater movement system, e.g., pan&tilt, and artificial intelligence (e.g., by means of CNN) for automatic classification allows to assist and eventually replace data analysis by an operator. This feature is particularly advantageous, as it allows the automatic or semi-automatic analysis of data originated from exploration of vast areas for a variety of purposes, which can range from geophysical surveys to clearing activities or other activities of interest in various fields.

The possibility to specialise the system towards particular categories of elements to be discovered and classified is also advantageous, such as underwater gaseous emissions as well as specific objects lying on the seabed or present in suspension. In this regard, the visualization customised and oriented to the analysis of particular targets is particularly useful (such customisation can relate, for example, to the spatial filtering techniques adopted and/or the possibility of “colouring” the acquired point cloud during display).

It is clear that changes and variations can be made to what herein described and illustrated without departing from the scope of the present solution, as defined in the appended claims.

In principle, the use of the system is not only limited to the analysis of the seabed but also of objects which can be floating in water, fixed or moving. The system described may be used for the analysis of various elements of interest, e.g., geophysical phenomena or items intentionally or unintentionally present on the seabed.

Moreover, the aforesaid classification phase (in addition to the searching phase) could also be carried out in some cases using, at least in part, the motion of the platform.

The system may comprise additional sensors and a georeferencing and attitude estimation system for software image correction.

Even the decision of the signal to be transmitted could be automated as a function of how the mission evolves. For example, the duration could be varied as a function of the desired range resolution and there could be a passage from CW (Continuous Wave) to FM (Frequency Modulated) signals as a function of various parameters such as reverberation reduction or increased sensitivity with respect to the Doppler shift.

Furthermore, the platform to which the system is coupled for the execution of the image acquisition and analysis could consist of any aquatic, surface or underwater vehicle. Such a platform is in any case subservient to the operation of the acoustic imaging system 1 with regard to the problem of locating and analysing the objects (of various kinds) to be searched at depth (e.g., on the seabed).

1. An underwater acoustic imaging system (1) designed to be coupled to a water vehicle (100) for inspection of a water volume, comprising:
an acoustic imaging device (2) configured to acquire, in real time, three-dimensional acoustic images relating to said water volume;
a mechanical movement module (3) coupled to the acoustic imaging device (2) to cause underwater movement thereof; and
an electronic unit (4) coupled to said acoustic imaging device (2) and mechanical movement module (3),
wherein said electronic unit (4) is configured to control said mechanical movement module (3) for the implementation of two distinct operating phases of said acoustic imaging device (2), cooperating to generate a continuous stream of said three-dimensional acoustic images: a searching phase, in which said acoustic imaging device (2) is designed to be held substantially still and is configured to scan said water volume as a result of a movement of said water vehicle (100); and an in-depth analysis phase, in which said acoustic imaging device (2) is designed to be driven in a scanning movement by said mechanical movement module (3) for an in-depth analysis of an element of interest identified in said water volume.

2. The system according to claim 1, wherein said electronic unit (4) is configured to control the mechanical movement module (3) to implement an automated transition between said searching phase and said in-depth analysis phase, following detection of said element of interest in said water volume, for the purpose of generating said continuous stream of three-dimensional acoustic images.

3. The system according to claim 2, wherein said acoustic imaging device (2) is provided with an array of transmitting acoustic transducers (2a) and with an array of receiving acoustic transducers (2b), oriented crosswise to one another, said array of transmitting acoustic transducers (2a) being controlled to produce a transmitted beam and said array of receiving acoustic transducers (2b) being configured to be electronically steered to form a number of beams that are transverse to the transmitted beam, thus obtaining a plurality of image elements for each transmitted beam; and wherein the array of transmitting acoustic transducers (2a), during said searching phase, is held in a substantially still position and, during said in-depth analysis phase, is driven by said mechanical movement module (3) according to at least one degree of freedom of movement, in azimuth or in elevation.

4. The system according to claim 3, wherein said mechanical movement module (3) is configured to control the positioning of the array of transmitting acoustic transducers (2a) to determine at least a rotation thereof in a horizontal plane, which is parallel to or inclined relative to a seabed, at angular steps within an angular scanning range.

5. The system according to claim 4, wherein said angular scanning range is substantially of 360°.

6. The system according to claim 1, wherein said mechanical movement module (3) is a “pan&tilt” module.

7. The system according to claim 1, wherein said acoustic imaging device (2) is configured to operate at a first operating frequency and at a first operating distance from said element of interest during said searching phase; and at a second operating frequency, higher than the first operating frequency, and at a second operating distance from said element of interest, lower than said first operating distance, during said in-depth analysis phase.

8. The system according to claim 1, wherein said electronic unit (4) comprises an analysis module (8) coupled to said acoustic imaging device (2) and configured to receive acoustic imaging data and perform processing and analysis of said acoustic imaging data for identification of said element of interest in real time and in an autonomous manner.

9. The system according to claim 8, wherein said analysis module (8) is configured to implement functions of automatic detection of said element of interest with artificial intelligence techniques.

10. The system according to claim 9, wherein said electronic unit (4) is configured to control the mechanical movement module (3) to implement the transition between said searching phase and said in-depth analysis phase, in response to the automatic detection of said element of interest by said analysis module (8) during said searching phase.

11. The system according to claim 9, wherein said element of interest comprises at least one of a geophysical phenomenon or an item intentionally or unintentionally present in the water volume.

12. The system according to claim 9, wherein said analysis module (8) is configured to georeference the automatic detection of said element of interest by means of navigation data, so as to define an area of interest in which to perform said in-depth analysis phase.

13. The system according to claim 8, further comprising a displaying unit (9) coupled to the electronic unit (4) and configured to display representations of the acoustic imaging data and/or results of the analysis implemented by the analysis module (8); wherein said analysis module (8) is configured to interact with said display unit (9) in order to implement algorithms to highlight said elements of interest and follow the evolution thereof over time.

14. An underwater acoustic imaging method (1), comprising:
acquiring, in real time, three-dimensional acoustic images of a water volume by means of an acoustic imaging device (2);
controlling a mechanical movement module (3), coupled to the acoustic imaging device (2), to cause an underwater movement thereof so as to implement two distinct operating phases of said acoustic imaging device (2), cooperating to generate a continuous stream said three-dimensional acoustic images: a searching phase in which said acoustic imaging device (2) is designed to be held substantially still and is configured to scan said water volume as a result of a movement of said water vehicle (100); and an in-depth analysis phase, in which said acoustic imaging device (2) is designed to be driven in a scanning movement by said mechanical movement module (3) for the in-depth analysis of an element of interest identified in said water volume.

15. The method according to claim 14, further comprising performing processing and analysis of acoustic imaging data provided by said acoustic imaging device (2) for identification of said element of interest in real time and in an autonomous manner; wherein performing processing and analysis of imaging data comprises implementing functions of automatic detection of said element of interest with artificial intelligence techniques; further comprising controlling the mechanical movement module (3) to implement the automated transition between said searching phase and said in-depth analysis phase, in response to the automatic detection of said element of interest during said searching phase.
